(19) United States
(12) Patent Application Publication
(10) Pub. No.: US 2023/0308144 A1
(43) Pub. Date: Sep. 28, 2023

(54) INTER-USER ORTHOGONALITY ESTIMATION METHOD AND BASE STATION

(71) Applicant: NIPPON TELEGRAPH AND TELEPHONE CORPORATION, Tokyo (JP)

(72) Inventors: Daisei UCHIDA, Musashino-shi, Tokyo (JP); Tatsuhiko IWAKUNI, Musashino-shi, Tokyo (JP); Chunhsiang HUANG, Musashino-shi, Tokyo (JP); Shuki WAI, Musashino-shi, Tokyo (JP); Naoki KITA, Musashino-shi, Tokyo (JP); Takeshi ONIZAWA, Musashino-shi, Tokyo (JP)

(73) Assignee: NIPPON TELEGRAPH AND TELEPHONE CORPORATION, Tokyo (JP)

(21) Appl. No.: 18/023,231

(22) PCT Filed: Aug. 31, 2020
(86) PCT No.: PCT/JP2020/032899

§ 371 Date: Feb. 24, 2023

(51) Int. Cl. H04B 7/0452; G01S 5/02

(52) U.S. Cl. CPC H04B 7/0452; G01S 5/0284

(57) ABSTRACT

A method of estimating inter-user orthogonality in a distributed antenna system in which a base station includes a plurality of distributed antennas installed at a plurality of locations and which performs simultaneous radio transmissions with a plurality of user stations, the method of estimating inter-user orthogonality including the steps of: estimating a position of each of the user stations on the basis of installation positions of the plurality of distributed antennas, beam directions of the plurality of distributed antennas to each user station being a radio transmission partner, and an antenna height of each of the user stations; estimating an interference radio wave direction on the basis of the position of each of the user stations estimated in the step of estimating a position and installation positions of the plurality of distributed antennas; and calculating an angle difference between the beam direction and the interference radio wave direction to estimate orthogonality between the user stations.

### TECHNICAL FIELD

The present invention relates to a method and a base station for estimating inter-user orthogonality.

### BACKGROUND ART

Due to the proliferation of digital signage, public viewing, and electronic sports (hereinafter, referred to as “Esports”), needs for bulk stream transfer of 4 k/8 k video, AR (Augmented Reality)/VR (Virtual Reality) data, and the like are being actualized. Furthermore, due to the proliferation of AI (Artificial Intelligence) analysis and automated driving of vehicles using big data, needs for bulk data transfer of storage data such as map data, video data and sensor data are also being actualized.

Terminals to be a target of bulk data transfer are not limited to fixed terminals such as a signage display and a viewing display but are also spreading to user terminals such as a smart phone and a tablet as well as mobile terminals installed in mobile bodies such as automobiles and train cars. Realization of bulk high-speed radio communication capable of providing such bulk transfer to such terminals is desired.

As such bulk high-speed radio communication, a distributed antenna system utilizing a high frequency band such as a millimeter wave band or a terahertz wave band is attracting attention. A millimeter wave band and a terahertz band enable a signal band of 1 GHz or more to be secured and enable gigabit wireless of 1 Gbps or more to be achieved even in a modulation-demodulation system operating in low CNR (carrier-noise ratio) environments of BPSK (Binary Phase Shift Keying) and QPSK (Quadrature Phase Shift Keying). When combined with multi-value modulation of 64 QAM (Quadrature Amplitude Modulation) or 256 QAM and MIMO technology for spatial multiplex transmission, there is a potential for realizing ultra-high speed radio transmission of 100 Gbps or more.

However, since high frequency bands have a large diffraction loss, unlike low frequency bands equal to or lower than the microwave band, radio waves do not reach a receiving station from a transmitting station and radio transmission is difficult in a non-line-of-sight environment where a shielding object such as a human body or a building exists along a radio wave propagation path. A distributed antenna system is effective as a countermeasure against such a non-line-of-sight environment. A distributed antenna system is a system capable of transmitting and receiving radio waves to and from each terminal from a plurality of directions by extending a plurality of distributed antennas from one base station and arranging the distributed antennas at different places. Accordingly, each terminal can perform line-of-sight communication with the base station as long as a line-of-sight is established with any one of the plurality of distributed antennas. Therefore, a high frequency band for realizing ultra-high speed radio transmission can be utilized even in a shielded environment or a moving environment.

On the other hand, in the distributed antenna system, since the base station is provided with a plurality of distributed antennas, multi-user transmission can be performed, and not only one user's ultra-high speed but also an ultra-large volume can be realized by increasing the number of simultaneous user transmissions. However, radio quality during multi-user transmission depends on inter-user interference. Therefore, it is necessary to estimate orthogonality between users and to appropriately select a user station set having high orthogonality. For example, let us assume that there are 200 users under a distributed antenna system and that, desirably, the number of multi-user transmissions is set to four stations or, in other words, simultaneous radio transmission is to be performed with four users. In this case, the radio quality when four stations are selected from the 200 stations depends on the mutual inter-user orthogonality of the selected four stations, and the larger the orthogonality, the smaller the interference between the users. Therefore, the way of selecting four stations from 200 stations is greatly attributable to the radio quality at the time of multi-user transmission. In addition, in order to appropriately select four stations, there is a need to be able to analogize orthogonality between the users of 200 user stations.

As a method of estimating the orthogonality between users, a method of estimating the orthogonality between users from MIMO (Multi-Input Multi-Out) channels of all users (hereinafter referred to as “a first estimation method”) is known (for example, refer to NPL 1). The MIMO channels of all users refer to propagation channels of all combinations between all distributed antennas included in a base station and antennas of all user stations under the control of a distributed antenna system. For example, let us assume that the number of distributed antennas provided in the base station is M and that the number of each distributed antenna is #1, 2, 3, . . . , M. Let us also assume that the number of user stations is N, the number of each user station is #1, #2, #3, . . . , #N, and that the number of antennas provided in each user station is one for the sake of simplicity. In this case, the MIMO channels of all the users on a downlink from each distributed antenna of the base station to each user station are represented by a matrix H of N rows and M columns as represented by expression (1) below.

$$[ Math . 1 ]$$

$$( \begin{matrix}{r}_{1} \\ {r}_{2} \\ ⋮ \\ {r}_{N}\end{matrix} ) = H \times ( \begin{matrix}{t}_{1} \\ {t}_{2} \\ ⋮ \\ {t}_{M}\end{matrix} ) , H = ( \begin{matrix}{h}_{11} & {h}_{12} & … & {h}_{1 M} \\ {h}_{21} & {h}_{22} & … & {h}_{2 M} \\ ⋮ & ⋮ & ⋱ & ⋮ \\ {h}_{N 1} & {h}_{N 2} & … & {h}_{NM}\end{matrix} ) \qquad ( 1 )$$

In expression 1, r₁, r₂, . . . , r_{N} represent reception signals of the user stations #1, #2 , #3, . . . , #N, t₁, t₂, . . . , t_{M} represent transmission signals from each of the distributed antennas #1, #2 , #3, . . . , #M of the base station, and hᵢⱼ represents a propagation channel between the distributed antenna #j of the base station to the user station #i. In this case, if the propagation channel H can be estimated, orthogonality between the user station #a and the user station #b (1≤a, b≤N, a≠b) can be estimated from orthogonality of row vectors V_{#a} and V_{#b} corresponding to the user stations #a and #b in the MIMO channels H. The row vectors V_{#a} and V_{#b} are represented by expression (2) below.

[Math. 2]

V_{#a}=(hₐ₁ hₐ₂ . . . h_{aM})

V_{#b}=(h_{b1} h_{b2} . . . h_{bM}) (2)

For example, an angle θ_{ab} formed by V_{#a} and V_{#b} can be calculated by expression (3) below and orthogonality can be estimated such that the closer the angle θ_{ab} is to 90 degrees, the higher the orthogonality.

[Math. 3]

cos⁻¹θ_{ab}=(V_{#a}·V_{#b})/(|V_{#a}| |V_{#b}|) (3)

In expression (3), (V_{#a}·V_{#b}) represents an inner product value of V_{#a} and V_{#b} and (|V_{#a}| |V_{#b}|) represents a second-order norm of V_{#a} and V_{#b}.

This estimation method is on the premise that the MIMO channels H of all users can be estimated. However, in the case of a high frequency band, there are two conceivable cases where an overhead for this estimation becomes large.

The first conceivable case is due to the fact that, in the case of a high frequency band, it is necessary to use a directional antenna having a large antenna gain in order to improve a system gain in order to perform long-distance radio transmission because of a large radio wave propagation attenuation.

As cases using a directional antenna, (i) and (ii) below are conceivable as representative examples.

Case (i): A user station is a non-directional antenna but distributed antennas of a base station are all directional antennas.

Each user station performs radio transmission to all distributed antennas of the base station.

When all distributed antennas of the base station perform radio transmission to a given user station, the distributed antennas orient a beam direction to the user station.

Case (ii): The user station and the distributed antennas of the base station are all directional antennas.

Each user station only performs radio transmission to a distributed antenna with a largest reception sensitivity among all of the distributed antennas of the base station.

Each user station and a distributed antenna being a radio transmission partner thereof orient beam directions to each other.

The case (i) will be considered as an example with respect to MIMO channels of all users when using a directional antenna. When a beam direction of the directional antenna differs, reception intensity changes according to a radiation direction of radio waves such that, when a propagation channel conceivably includes a directivity gain of the directional antenna, the propagation channel changes for each beam direction. Therefore, in case (i), expression (1) is represented by expression (4) below for each set of beam directions of all distributed antennas of the base station corresponding to each user station #i (i=1, 2, . . . , N).

$$[ Math . 4 ]$$

$$( \begin{matrix}{r}_{1} \\ {r}_{2} \\ ⋮ \\ {r}_{N}\end{matrix} ) = {H}^{i} \times ( \begin{matrix}{t}_{1} \\ {t}_{2} \\ ⋮ \\ {t}_{M}\end{matrix} ) , {H}^{i} = H \times {B}^{i} , {B}^{i} = ( \begin{matrix}{B}_{11}^{i} & {B}_{12}^{i} & … & {B}_{1 N}^{i} \\ {B}_{21}^{i} & {B}_{22}^{i} & … & {B}_{2 N}^{i} \\ ⋮ & ⋮ & ⋱ & ⋮ \\ {B}_{M 1}^{i} & {B}_{M 2}^{i} & … & {B}_{MN}^{i}\end{matrix} ) \qquad ( 4 )$$

In expression (4), a matrix Bⁱ represents a matrix of M rows and N columns indicating a directivity gain in a direction of the user station #n when the beam direction of the distributed antenna #m of the base station is oriented toward the user station #i. The matrix Bⁱ exists for each user station #i (i=1, 2, . . . , N) and, consequently, MIMO channels Hⁱ of all users also exist for each user station. A propagation channel when the user station #i and the user station #j perform simultaneous radio transmission is a superposition Hⁱ+H^{j} of MIMO channels Hⁱ and H^{j}, and orthogonality between both users is calculated by calculating expression (3) with respect to Hⁱ+H^{j}. Therefore, in order to calculate orthogonality between arbitrary users, it is necessary to obtain all MIMO channels Hⁱ (i=1, 2, . . . , N) for all users.

The estimation of the MIMO channels Hⁱ (i=1, 2, . . . , N) for all users requires, in the case of a down direction, transmitting a pilot signal for each distributed antenna of each base station and for each beam direction to each user. Therefore, it is necessary to transmit pilot signals corresponding to the number of distributed antennas times the number of users in a time-shared manner. On the other hand, when the distributed antennas of the base station are non-directional antennas, it is only necessary to estimate the propagation channel H of expression (1) and to transmit pilot signals corresponding to the number of distributed antennas. For example, when the number of distributed antennas is 16 and the number of users is 200, compared to the need to transmit only 16 pilot signals in a time-shared manner when not using a directional antenna, there is a need to transmit 16×200=3,200 pilot signals in a time-shared manner when using a directional antenna which represents a significant increase in the amount of necessary pilot transmissions.

Although the number of MIMO channels required for actual radio transmission is equal to the number of distributed antennas times the number of multi-user transmissions, even if the number of multi-user transmissions is 16 which is the same as the number of distributed antennas, only 16×16=256 pilots necessary for estimation may be transmitted in a time-shared manner. Therefore, when the number of all users is larger than the number of multi-user transmissions, the number of pilot signals required for the MIMO channels Hⁱ (i=1, 2, . . . , N) for all users necessary for user selection exceeds the number of multi-user transmissions by a corresponding amount.

As described above, in the case of a high-frequency band, it is necessary to use a directional antenna for long-distance transmission, and when using a directional antenna, MIMO channels Hⁱ (i=1, 2, . . . , N) for all users must be estimated in order to calculate arbitrary inter-user orthogonality. For this purpose, the number of required pilot transmissions equals the number of distributed antennas times the number of users, and this number is larger than the number of pilot transmissions (the number of distributed antennas times the number of multi-user transmissions) required for multi-user transmission. In particular, when the number of users is greatly increased, the difference becomes large, and transmission efficiency is greatly deteriorated.

Next, the second conceivable case where an overhead of estimation of the MIMO channels H of all users becomes large in the case of a high frequency band will be described. The second conceivable case is attributable to the fact that, since not only a directional antenna but shielding loss is also large in the case of a high frequency band, radio waves are only radiated and arrive in a certain specific direction.

Since a high-frequency band sustains large shielding loss and diffraction loss due to buildings and people, radio waves from directions where these shielding objects exist are remarkably attenuated compared with a line-of-sight direction. Even when there are a plurality of line-of-sight directions, if the user station uses a directional antenna, since radio waves other than a beam direction are attenuated by a directivity pattern, transmitting and receiving only radio waves in the line-of-sight directions will suffice. Therefore, when the user station uses a directional antenna and the surroundings are a shielded environment, performing radio transmission to only one distributed antenna to which a line-of-sight has been secured will suffice. This corresponds to the case (ii) described above.

Since a sparse direction of arrival of interference radio waves from other user stations is also greatly attenuated in directions other than the beam direction or in the direction of the shielded environment, the possibility of the influence of the interference radio waves is extremely low. Therefore, pre-coding/post-coding for improving system gain and reducing inter-user interference are not required, and estimation of MIMO channels H of all users itself is not required for radio signal transmission. Therefore, in order to calculate expression (3) for user orthogonality, the MIMO channels H of all users must be estimated separately from the radio signal transmission. In addition, since the estimation requires time division transmission of pilot signals equal to or more than the number of all users, a large overhead is generated and transmission efficiency deteriorates.

From the above, a high frequency band is problematic in that a large overhead occurs in estimation of the MIMO channels H of all users and transmission efficiency deteriorates. For this reason, desirably, the estimation of inter-user orthogonality is not performed according to a method of calculating from the MIMO channels H of all users as represented by expression (3) but performed according to a method that does not require the MIMO channels H of all users.

On the other hand, when the base station is provided with one distributed antenna, that is, when an antenna of the base station is installed at one place, a method (hereinafter referred to as “a second estimation method”) of estimating inter-user orthogonality from an angle difference in beam directions to each user station without using the MIMO channels H of all users is known (refer to NPL 2).

When the base station antenna is installed at one place and multi-user transmission is performed in a high frequency band, different beams are oriented from the same antenna to each user station and the beams are simultaneously transmitted. In this case, an interference radio wave direction from the base station antenna to an interference user station coincides with an angle difference between a beam direction of the user station being a radio transmission partner and a beam direction of the other user station. Since the larger the angle difference, the smaller an interference radio wave due to a directivity gain pattern, inter-user orthogonality is improved. Therefore, inter-user orthogonality can be estimated based on an angle difference between beams.

However, when this method is applied to distributed antennas in which a plurality of antennas are installed at different places, a distributed antenna of a radio transmission partner of each user station differs. Therefore, a source of a beam direction to each user station differs. Accordingly, a direction of an interference radio wave from each distributed antenna to the interference user station does not coincide with an angle difference between the beam direction of the user station being the radio transmission partner and the beam direction of the other user station.

FIGS. 16 and 17 illustrate an outline of the above. FIG. 16 shows a configuration which, in a total system by radio including a base station 1 and two user stations 2-1 and 2-2, the user stations 2-1 and 2-2 perform radio transmission with a same distributed antenna 3. FIG. 17 shows a configuration which, in the total system by radio including the base station 1 and the two user stations 2-1 and 2-2, the user stations 2-1 and 2-2 perform radio transmission with different distributed antennas 4 and 5.

In the configuration shown in FIG. 16, when viewed from a beam direction V₁ of the distributed antenna 3 toward the user station 2-1, an angle difference between a direction of an interference radio wave to the user station 2-2 and a beam direction V₂ is the same because sources of both are coincident with each other.

On the other hand, in the configuration shown in FIG. 17, it is assumed that the user station 2-1 and the user station 2-2 perform radio transmission with the distributed antenna 4 and the distributed antenna 5 of the base station, respectively, and the beam directions of the distributed antennas 4 and 5 in the directions of the user stations 2-1 and 2-2 are the beam directions V₁ and V₂. An interference radio wave direction of the user station 2-2 viewed from the distributed antenna 4 is an angle difference between the beam direction V₁ and a direction from the distributed antenna 4 to the user station 2-2 as shown in FIG. 17.

On the other hand, an angle difference between the beam direction V₁ and the beam direction V₂ is an angle difference after matching sources since the sources differ as shown in FIG. 17. In this way, since a partner to be compared with the beam direction V₁ is in the direction of the user station 2-2 as viewed from the distributed antenna 4 in the case of an interference radio wave direction but a source is in the direction of the user station 2-2 as viewed from the distributed antenna 5 in the case of an angle difference of a beam direction, sources differ and the directions do not coincide with each other. Therefore, since the angle difference between the beam directions does not reflect the direction of interference radio waves between the user stations, that is, an amount of interference in the case of using a directional antenna, it is difficult to estimate inter-user orthogonality from the beam directions.

### CITATION LIST

### Non Patent Literature

[NPL 1] Bo Zhou, Baoming Bai, Ying Li, Daqing Gu, Yajuan Luo, “Chordal distance-based user selection algorithm for the multiuser MIMO downlink with perfect or practical CSIT”, IEEE AINA 2011, pp. 77-82, March 2011.
[NPL 2] Hiroyuki Miyazaki, Satoshi Suyama, Tatsuki Okuyama, Jun Mashino, Yukihiko Okumura, “User Selection Algorithm for High SHF Wideband Multi-User Massive MIMO Using Hybrid Beamforming”, IEICE Technical Report RCS 2016-308, March 2017.

### SUMMARY OF INVENTION

### Technical Problem

As described above, in the first estimation method described in NPL 1, since pilot signals required for obtaining the MIMO channels H of all users are proportional to the number of users, transmission efficiency problematically deteriorates. In the second estimation method described in NPL 2, since an angular difference between beam directions does not coincide with a direction of an interference radio wave in the case of a distributed antenna, inter-user orthogonality is not reflected and inter-user orthogonality cannot be estimated more accurately. As described above, in conventional methods, when estimating inter-user orthogonality during multi-user transmission, there are problems in that transmission efficiency deteriorates and the number of distributed antennas of the base station is limited.

In view of the circumstances described above, an object of the present invention is to provide a technique that enables, when estimating inter-user orthogonality during multi-user transmission, deterioration in transmission efficiency to be suppressed and inter-user orthogonality to be estimated even when a base station has a plurality of distributed antennas.

### Solution to Problem

An aspect of the present invention is a method of estimating inter-user orthogonality in a distributed antenna system in which a base station includes a plurality of distributed antennas installed at a plurality of locations and which performs simultaneous radio transmissions with a plurality of user stations, the method of estimating inter-user orthogonality including the steps of: estimating a position of each of the user stations on the basis of installation positions of the plurality of distributed antennas, beam directions of the plurality of distributed antennas to each user station being a radio transmission partner, and an antenna height of each of the user stations; estimating an interference radio wave direction on the basis of the position of each of the user stations estimated in the step of estimating a position and installation positions of the plurality of distributed antennas; and calculating an angle difference between the beam direction and the interference radio wave direction to estimate orthogonality between the user stations.

An aspect of the present invention is a base station in a distributed antenna system in which a base station includes a plurality of distributed antennas installed at a plurality of locations and which performs simultaneous radio transmissions with a plurality of user stations, the base station including: a position estimating unit configured to estimate a position of each user station on the basis of installation positions of the plurality of distributed antennas, beam directions of the plurality of distributed antennas to each user station being a radio transmission partner, and an antenna height of each of the user stations; an interference direction estimating unit configured to estimate an interference radio wave direction on the basis of the position of each of the user stations estimated by the position estimating unit and installation positions of the plurality of distributed antennas; and an angle difference calculating unit configured to calculate an angle difference between the beam direction and the interference radio wave direction to estimate orthogonality between the user stations.

### Advantageous Effects of Invention

According to the present invention, when estimating inter-user orthogonality during multi-user transmission, deterioration in transmission efficiency can be suppressed and the inter-user orthogonality can be estimated even if a base station has a plurality of distributed antennas.

### BRIEF DESCRIPTION OF DRAWINGS

FIG. 1 is a diagram showing a configuration of a distributed antenna system according to a first embodiment.

FIG. 2 is a diagram showing a configuration of a base station according to the first embodiment.

FIG. 3 is a flowchart showing a flow of inter-user orthogonality estimation processing performed by the base station according to the first embodiment.

FIG. 4 is a diagram showing a configuration of the distributed antenna system when three user stations are provided.

FIG. 5 is a diagram showing a configuration of a base station according to a second embodiment.

FIG. 6 is a flowchart showing a flow of user station selection processing performed by the base station according to the second embodiment.

FIG. 7 is a diagram showing a configuration of a base station according to a third embodiment.

FIG. 8 is a flowchart showing a flow of user station selection processing performed by the base station according to the third embodiment.

FIG. 9 is a diagram of a configuration of a base station according to a fourth embodiment.

FIG. 10 is a flowchart showing a flow of user station selection processing performed by the base station according to the fourth embodiment.

FIG. 11 is a diagram showing a configuration of a base station according to a fifth embodiment.

FIG. 12 is a flowchart showing a flow of user station selection processing performed by the base station according to the fifth embodiment.

FIG. 13 is a flowchart showing a flow of user station selection processing when the user station selection processing performed by the base station according to the fifth embodiment is applied to the fourth embodiment.

FIG. 14 is a diagram showing a configuration of a base station according to a sixth embodiment.

FIG. 15 is a flowchart showing a flow of user station selection processing performed by the base station according to the sixth embodiment.

FIG. 16 is a diagram for explaining a conventional method of estimating inter-user orthogonality.

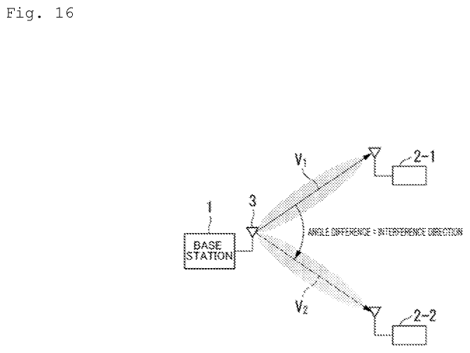

FIG. 17 is a diagram for explaining a conventional method of estimating inter-user orthogonality.

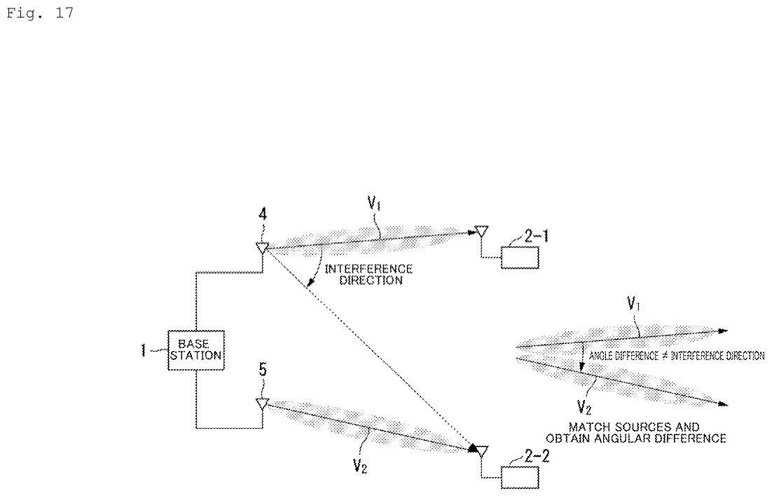

### DESCRIPTION OF EMBODIMENTS

Hereinafter, an embodiment of the present invention will be described with reference to the drawings.

### (Overview)

A base station in a distributed antenna system according to the present invention is configured to, in order to appropriately select a set of user stations having high inter-user orthogonality during multi-user transmission, estimate inter-user orthogonality without estimating MIMO channels H of all users of which overhead is large and transmission efficiency deteriorates as in NPL 1 and without limiting the number of distributed antennas to one as in NPL 2. Specifically, a base station is a distributed antenna system including a plurality of distributed antennas which enables an interference radio wave direction to be calculated by estimating not only a beam direction of a base station antenna according to NPL 2 but also a position of a user station, and analogizes inter-user orthogonality.

A position of a user station and a direction of interference radio waves are calculated as follows. In view of the features of a high frequency band, the distributed antenna of the base station uses a directional antenna for long-distance transmission, and since shielding loss and diffraction loss are large, it is highly likely that radio transmission with respect to each user station is to be performed in a line-of-sight environment. By utilizing this feature, a beam direction of each distributed antenna is assumed to be a direction of presence of a user station being a radio transmission partner, and assuming that an antenna height of each user station can be analogized, an intersection point between the beam direction and a plane with a constant antenna height of the user station is estimated as each user station position. In addition, the base station adopts a direction of a user station being a radio transmission partner as a beam direction, obtains a direction of another user station from the analogized user station position, and calculates an angle difference. The angle difference is equivalent to the direction of the interference radio wave because sources of two vectors for calculating the angle difference are located at a position of a same distributed antenna, and the angle difference can be analogized as inter-user orthogonality.

If an analogized position of the other user station is correct, the calculated angular difference coincides with the deviation itself from a beam center of a directional antenna of a distributed antenna provided in the base station, that is, the direction of the interference radio wave. Therefore, since the larger the angle difference, the smaller the directivity gain and the more the interference radio wave to be given to the other user station is attenuated, an amount reflecting the inter-user orthogonality is obtained. The correctness of the analogized position of the other user station depends on the fact that an antenna height of the user station can be analogized and whether or not the user station being the radio transmission partner actually exists in the beam direction of the distributed antenna.

In the former case, for example, in an indoor environment or the like, the height of a terminal used by a person is around 0 to 1.5 m above floor level, and even in an outdoor environment, as long as a service area such as a road, a sidewalk, or a public area is an area that is more or less level, the height of a terminal used by a person can be analogized to be round 0 to 1.5 m above ground level. In the latter case, as described above, since shielding loss and diffraction loss are large in a high frequency band, radio wave propagation in a line-of-sight environment is dominant, and even if a reflected wave is generated, installing the distributed antenna of the base station in an environment where there is no shielding object in its periphery causes reflected waves from a shielding object in the periphery of the user station to be dominant, and in this case, a direction of the user station as viewed from the distributed antenna is almost the same as a direction of a reflected wave of a direction of a line-of-sight wave. Therefore, it is conceivable that there are many cases where a beam direction of a distributed antenna coincides with a direction in which a user station being a radio transmission partner is present.

According to the above-described method, in the present invention, inter-user orthogonality is estimated based on a position of each distributed antenna, a beam direction, and an antenna height of a user station (a constant height is assumed). Therefore, MIMO channels H of all users need not be estimated as in the conventional first estimation method, and even when there are a plurality of distributed antennas instead of one distributed antenna as in the conventional second estimation method, inter-user orthogonality can be estimated. In the following description, a specific configuration for estimating inter-user orthogonality by the method described above will be described in the first embodiment, and methods of selecting a user during multi-user transmission will be described in second to sixth embodiments.

### First Embodiment

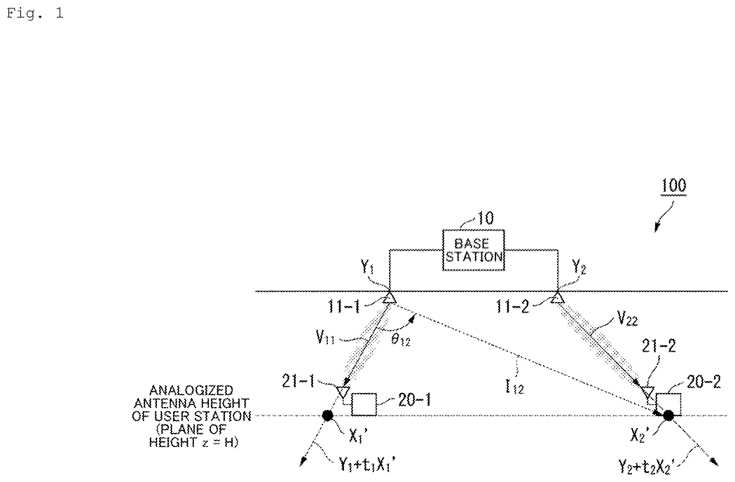

FIG. 1 is a diagram showing a configuration of a distributed antenna system 100 according to the first embodiment. The distributed antenna system 100 includes a base station 10 and a plurality of user stations 20-1 to 20-2. Although FIG. 1 shows a configuration in which two user stations 20 are provided in the distributed antenna system 100, three or more user stations 20 may be provided.

The base station 10 performs communication by multi-user transmission with the user stations 20-1 to 20-2. The base station 10 is provided with a plurality of distributed antennas 11-1 to 11-k (where k is an integer equal to or larger than 2). FIG. 1 shows a configuration in which the base station 10 is provided with two distributed antennas 11 (the distributed antennas 11-1 and 11-2). Each of the distributed antennas 11-1 and 11-2 is arranged at a different place.

The user stations 20-1 to 20-2 communicate with the base station 10 via the distributed antenna 11. A user station is, for example, an information processing device such as a smartphone, a tablet terminal, or a mobile phone. Radio transmission between each distributed antenna 11 and the user station 20 will be described on the assumption that the radio transmission is to be performed in the form of case (ii) described earlier. That is, each user station 20 performs radio transmission only to one distributed antenna 11 having largest reception intensity of radio waves transmitted from all distributed antennas 11-1 to 11-2 of the base station 10.

As an example, in the following description, it is assumed that a set made up of the distributed antenna 11-1 and the user station 20-1 and a set made up of the distributed antenna 11-2 and the user station 20-2 perform radio transmission. First, the following definitions will be adopted when providing a specific description.

Respective positions of distributed antennas 11-1 and 11-2: Y₁ and Y₂

Respective beam directions to user stations 20-1 and 20-2 being radio transmission partners of distributed antennas 11-1 and 11-2: V₁₁ and V₂₂

Respective estimated positions of user stations 20-1 and 20-2: X₁′ and X₂′

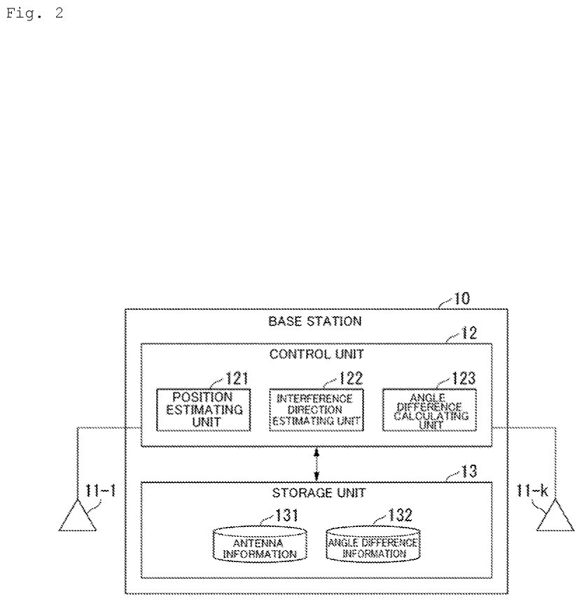

FIG. 2 is a diagram showing a configuration of the base station 10 according to the first embodiment. The base station 10 includes the distributed antennas 11-1 to 11-2, a control unit 12, and a storage unit 13.

The control unit 12 is constituted of a processor such as a CPU (Central Processing Unit) and a memory. The control unit 12 executes a program to achieve functions of a position estimating unit 121, an interference direction estimating unit 122, and an angle difference calculating unit 123. Note that all or a part of these functional units may be realized by hardware (including circuit units and circuitry) such as an ASIC (Application Specific Integrated Circuit), a PLD (Programmable Logic Device), or an FPGA (Field Programmable Gate Array) or realized by cooperation between software and hardware.

The position estimating unit 121 estimates a position of each of the user stations 20-1 and 20-2 on the basis of an installation position of each distributed antenna 11, a beam direction of the distributed antenna 11 to each user station 20 being a radio transmission partner, and an antenna height of each user station.

The interference direction estimating unit 122 estimates an interference radio wave direction on the basis of the position of the user station 20 estimated by the position estimating unit 121 and the position of the distributed antenna 11. Specifically, the interference direction estimating unit 122 estimates an interference radio wave direction 112 of the user station 20-2 which interferes with (downlink) and is interfered with (uplink) in the distributed antenna 11-1 on the basis of the position Y₁ of the distributed antenna 11-1 and the estimated position X₂′ of the user station 20-2. The interference direction estimating unit 122 estimates an interference radio wave direction I₂₁ of the user station 20-1 which interferes with (downlink) and is interfered with (uplink) in the distributed antenna 11-2 on the basis of the position Y₂ of the distributed antenna 11-2 and the estimated position X₁′ of the user station 20-1.

The angle difference calculating unit 123 calculates an angle difference on the basis of the beam direction and the interference radio wave direction estimated by the interference direction estimating unit 122. Specifically, the angle difference calculating unit 123 calculates an angle difference θ₁₂ between a direction of the user station 20-1 and a direction of the user station 20-2 as viewed from the position Y₁ of the distributed antenna 11-1 on the basis of the beam direction V₁₁ and the interference radio wave direction I₁₂ of the user station 20-2.

The angle difference θ₁₂ represents user orthogonality of the user station 20-1 with respect to the user station 20-2. That is, by estimating the angle difference θ₁₂, it is possible to estimate user orthogonality of the user station 20-1 with respect to the user station 20-2. On the other hand, the angle difference θ₂₁ represents the user orthogonality of the user station 20-2 with respect to the user station 20-1. That is, by estimating the angle difference θ₂₁, it is possible to estimate user orthogonality of the user station 20-2 with respect to the user station 20-1.

The storage unit 13 stores antenna information 131 and angle difference information 132. The storage unit 13 is constituted by, for example, one or more of an HDD (Hard Disk Drive), an SSD (Solid State Drive), a mask ROM (Read Only Memory), an EPROM (Erasable Programmable Read Only Memory), an EEPROM (Electrically Erasable Programmable Read Only Memory), and the like.

The antenna information 131 is information related to the distributed antennas 11. The antenna information 131 includes, for example, information on installation positions Y₁ and Y₂ of the distributed antennas 11. When information on beam directions is acquired, the antenna information 131 may include information on a beam direction for each distributed antenna 11 or include information on the user stations 20-1 and 20-2 being radio transmission partners.

The angle difference information 132 is information on the angle difference calculated by the angle difference calculating unit 123.

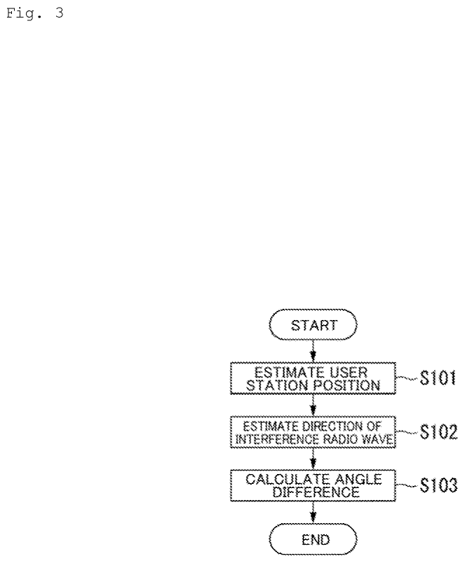

FIG. 3 is a flowchart showing a flow of inter-user orthogonality estimation processing that is performed by the base station 10 according to the first embodiment. The processing shown in FIG. 3 is executed before the base station 10 performs a multi-user transmission.

The position estimating unit 121 estimates the position of each of the user stations 20-1 and 20-2 (step S101). In preparation therefor, a linear expression of a beam direction of each of the distributed antennas 11-1 and 11-2 is determined by expression (5) below.

[Math. 5]

Straight line of beam direction of distributed antenna 11-1: Y₁+t₁V₁₁

Straight line of beam direction of distributed antenna 11-2: Y₂+t₂V₂₂ (5)

In expression (5), Y₁ and Y₂ represent positions of the distributed antennas 11-1 and 11-2, V₁₁ and V₂₂ represent beam directions to the user stations 20-1 and 20-2 being radio transmission partners of the distributed antennas 11-1 and 11-2, and t₁ and t₂ represent parameters of the respective linear expressions.

As a method of acquiring a beam direction, in the case of analog beamforming, a beam identifier such as a beam ID and a beam direction may be associated with each other in advance in one-to-one correspondence and a beam direction may be acquired by acquiring a beam identifier used upon radio transmission. In the case of an analog sector beam, the base station 10 may similarly associate a sector identifier such as a sector ID and a sector direction to each other in advance in one-to-one correspondence and acquire a beam direction by acquiring a sector identifier used upon radio transmission. In the case of digital beamforming, the base station 10 may acquire a beam direction according to a method of associating a pre-coding pattern and a beam direction to each other in advance in one-to-one correspondence and acquiring a beam direction by acquiring a pre-coding pattern used upon radio transmission. The base station 10 may include a plurality of sub-antennas of fixed directional beams at one place, associate each sub-antenna to a beam direction in one-to-one correspondence in advance, and acquire information on a sub-antenna used upon radio transmission. Any method may be adopted as long as a plurality of beam directions can be realized and information on which beam direction had been used at the time of radio transmission can be acquired.

The beam directions V₁₁ and V₂₂ of the distributed antennas 11-1 and 11-2 are selected so that the reception intensity is maximized with respect to the user stations 20-1 and 20-2 in high frequency band radio such as IEEE 802.11ad and 5G New Radio (NR). Therefore, the user stations 20-1 and 20-2 more or less exist in a linear direction represented by expression (5) as viewed from the positions Y₁ and Y₂ of the distributed antennas 11-1 and 11-2, albeit containing error corresponding to a beam width.

Next, an antenna height of the user stations 20-1 and 20-2 is assumed to be h. For example, a floor level is an example of an antenna height in an indoor environment and a ground level is an example of an antenna height in an outdoor environment, and these assumption are reasonable when most user stations exist on a same plane. At this point, assuming that a coordinate axis of a height is a z axis, the positions of the user stations 20-1 and 20-2 exist on a z=h plane. At this point, the positions X1 and X2 of the user stations 20-1 and 20-2 can be estimated from intersections of the linear expression represented by expression (5) and the plane z=h. The estimated positions are expressed as X₁′ and X₂′. For example, when three-dimensional vector components of Y₁, Y₂, V₁₁, and V₂₂ are expressed as in expression (6) below, three-dimensional vector components of X₁′ and X₂′ are expressed as in expression (6) below.

[Math. 6]

Y₁=(y₁₁,y₁₂,y₁₃)

Y₂=(y₂₁,y₂₂,y₂₃)

V₁₁=(v₁₁,v₁₂,v₁₃)

V₂₂=(v₂₁,v₂₂,v₂₃)

X₁=(y₁₁−y₁₃×v₁₁/v₁₃,y₁₂−y₁₃×v₁₂/v₁₃,0)

X₂=(y₂₁−y₂₃×v₂₁/v₂₃,y₂₂−y₂₃×v₂₂/v₂₃,0) (6)

The interference direction estimating unit 122 estimates an interference radio wave direction I₁₂ of the user station 20-2 which interferes with (downlink) and is interfered with (uplink) in the distributed antenna 11-1 on the basis of the position Y₁ of the distributed antenna 11-1 and the estimated position X₂′ of the user station 20-2 according to expression (7) below (step S102).

[Math. 7]

I₁₂=X₂′−Y₁ (7)

In addition, the angle difference calculating unit 123 calculates an angle difference θ₁₂ between a direction of the user station 20-1 and a direction of the user station 20-2 as viewed from the position Y₁ of the distributed antenna 11-1 on the basis of the beam direction V₁₁ and the interference radio wave direction I₁₂ of the user station 20-2 according to expression (8) below (step S103).

[Math. 8]

cos⁻¹θ₁₂=(V₁₁·I₁₂)/(|V₁₁| |I₁₂|) (8)

In expression (8), (V₁₁·I₁₂) represents an inner product value of V₁₁ and I₁₂ and (|V₁₁|, |I₁₂|) represents a second-order norm. The angle difference θ₁₂ corresponds to the angle difference of the direction of the user station 20-2 from the center of the beam direction of the distributed antenna 11-1, and the directional antenna of the distributed antenna 11-1 reflects a directional gain in the direction of the user station 20-2. That is, when the angle difference is 0 degrees, the direction of the user station 20-2 is the center of the beam direction itself, and when the angle difference is 45 degrees, a directivity gain shifted by 45 degrees from the center direction of the beam becomes an antenna gain to the user station 20-2 and reflects an amount of interference (downlink) that the distributed antenna 11-1 imparts to the user station 20-2 or an amount of interference (uplink) that the distributed antenna 11-1 is imparted from the user station 20-2.

Similarly, an angle difference θ₂₁ between a direction of the user station 20-2 and a direction of the user station 20-1 as viewed from the position Y₂ of the distributed antenna 11-2 can be calculated on the basis of the interference radio wave direction I₂₁=X′−Y₂ of the user station 20-1 which interferes with and is interfered with in the distributed antenna 11-2 and the beam direction V₂₂ according to expression (9) below.

[Math. 9]

cos⁻¹θ₂₁=(V₂₂·I₂₁)/(|V₂₂| |I₂₁|) (9)

Similarly, the angle difference θ₂₁ reflects an amount of interference (downlink) that the distributed antenna 11-2 imparts to the user station 20-1 and an amount of interference (uplink) that the distributed antenna 11-2 is imparted from the user station 20-1.

As described above, the angle differences θ₁₂ and θ₂₁ (hereinafter, referred to as “angle difference between two user stations”) reflect amounts of user interference of an uplink and a downlink between the user station 20-1 and the user station 20-2. That is, inter-user orthogonality between the user station 20-1 and the user station 20-2 can be reflected and inter-user orthogonality can be estimated.

According to the distributed antenna system 100 configured as described above, the position of each user station 20 is estimated on the basis of the installation position of each distributed antenna 11, the beam direction of the distributed antenna 11, and the antenna height of each user station 20, an interference direction is estimated from the estimated position of each user station 20, and inter-user orthogonality can be estimated on the basis of an angle difference between the beam direction and the interference direction of the distributed antenna 11. Thus, in the distributed antenna system 100, it is not necessary to estimate the MIMO channels of all users of which overhead is large and transmission efficiency is deteriorated as in the conventional first estimation method. Furthermore, it is possible to estimate inter-user orthogonality even when a plurality of distributed antennas 11 are provided. Therefore, when estimating inter-user orthogonality during multi-user transmission, deterioration in transmission efficiency can be suppressed and inter-user orthogonality can be estimated even if a base station has a plurality of distributed antennas.

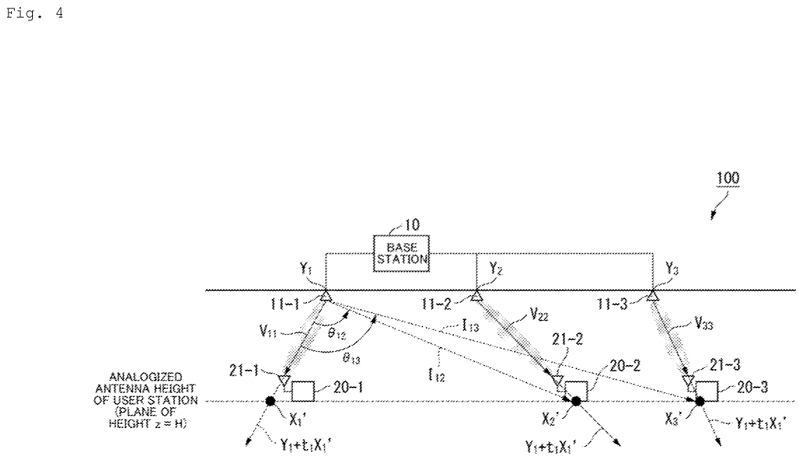

A modification of the first embodiment will be described. Although a configuration in which the distributed antenna system 100 is provided with two distributed antennas 11 and two user stations 20 has been described in the embodiment presented above, even when three distributed antennas 11 (distributed antennas 11-1 to 11-3) and three user stations 20 (user stations 20-1 to 20-3) are provided, inter-user orthogonality can be estimated by performing processing similar to that described above. A specific description will be given with reference to FIG. 4.

FIG. 4 is a diagram showing a configuration of the distributed antenna system 100 in the case where three user stations are provided. The distributed antenna system 100 includes the base station 10 and a plurality of user stations 20-1 to 20-3. The base station 10 shown in FIG. 4 includes three distributed antennas 11. Radio transmission partners of the distributed antennas 11-1, 11-2, and 11-3 are assumed to be the user stations 20-1, 20-2, and 20-3. In a similar manner to that described above, first, the position estimating unit 121 determines, from positions Y₁, Y₂, and Y₃ and beam directions V₁₁, V₂₂, and V₃₃ of the distributed antennas 11-1, 11-2, and 11-3, each linear expression of the beam directions as represented by expression (10) below.

[Math. 10]

Straight line of beam direction of distributed antenna 11-1: Y₁+t₁V₁₁

Straight line of beam direction of distributed antenna 11-2: Y₂+t₂V₂₂

Straight line of beam direction of distributed antenna 11-3: Y₃+t₃V₃₃ (10)

The position estimating unit 121 calculates estimated positions X₁′, X₂′, and X₃′ of the user stations 20-1, 20-2, and 20-3 from the linear expressions obtained by expression (10) and intersection points on the plane at antenna height x=h of the user stations 20-1, 20-2, and 20-3. Then, the interference direction estimating unit 122 calculates interference radio wave directions I₁₂ and I₁₃ of the user stations 20-2 and 20-3 which interfere with or which are interfered with in the distributed antenna 11-1 from expression (11) below in a similar manner to that described earlier.

[Math. 11]

I₁₂=X₂′−Y₁

I₁₃=X₃′−Y₁ (11)

Subsequently, the antenna information 131 calculates angle differences θ₁₂ and θ₁₃ between the beam direction V₁₁ of the distributed antenna 11-1 and I₁₂ and I₁₃ on the basis of expression (12) below.

[Math. 12]

cos⁻¹θ₁₂=(V₁₁·I₁₂)/(|V₁₁| |I₁₂|)

cos⁻¹θ₁₃=(V₁₁·I₁₃)/(|V₁₁| |I₁₃|) (12)

In a similar manner to that described above, the angle differences θ₁₂ and θ₁₃ reflect amounts of interference (downlink) that the distributed antenna 11-1 imparts to the user stations 20-2 and 20-3 or amounts of interference (uplink) that the distributed antenna 11-1 is imparted from the user stations 20-2 and 20-3. In a similar manner to expressions (10) to (12), angle differences θ₂₁ and θ₂₃ between the beam direction V₂₂ of the distributed antenna 11-2 and the interference radio wave directions I₂₁ and I₂₃ to the user stations 20-1 and 20-3 which interfere with or which are interfered with in the distributed antenna 11-2 and angle differences θ₃₁ and θ₃₂ between the beam direction V₃₃ of the distributed antenna 11-3 and the interference radio wave directions 131 and 132 to the user stations 20-1 and 20-2 which interfere with or which are interfered with in the distributed antenna 11-3 can be calculated.

As described above, the angle differences θ₁₂, θ₁₃, θ₂₁, θ₂₃, θ₃₁, and θ₃₂ reflect amounts of user interference of an uplink and a downlink among the user station 20-1, the user station 20-2, and the user station 20-3. That is, inter-user orthogonalities among the user station 20-1, the user station 20-2, and the user station 20-3 are reflected and inter-user orthogonality can be estimated.

While embodiments of the present invention in cases where there are two distributed antennas, three distributed antennas, two user stations, and three user stations have been described above, an angle difference between a beam direction and an interference radio wave direction of each distributed antenna can be calculated and inter-user orthogonality can be estimated in a similar manner to above even when there are four or more distributed antennas, when there are four or more user stations, and even when the number of distributed antennas and the number of user stations are not the same.

### Second Embodiment

A second embodiment represents an embodiment in which, using an angle difference between two user stations 20-1 and 20-2 according to the first embodiment, sets of user stations corresponding to the number of multi-user transmissions are selected from all the user stations 20. Specifically, the second embodiment represents a method of calculating an angle difference between two user stations for all combinations of a set of user stations 20 for selecting the number of multi-user transmissions from all the user stations 20 and selecting an optimum user station on the basis of the angle differences. That is, the second embodiment represents a method of selecting an optimum user station by performing a full search for angular differences of all combinations.

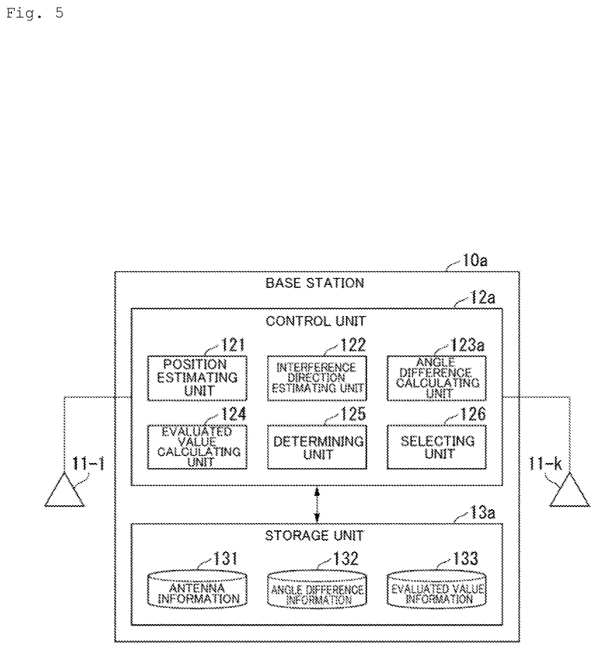

FIG. 5 is a diagram showing a configuration of a base station 10a according to the second embodiment. The base station 10a is provided with distributed antennas 11-1 to 11-2, a control unit 12a, and a storage unit 13a.

The control unit 12a is constituted of a processor such as a CPU and a memory. The control unit 12a executes a program to achieve functions of a position estimating unit 121, an interference direction estimating unit 122, an angle difference calculating unit 123a, an evaluated value calculating unit 124, a determining unit 125, and a selecting unit 126. A part of or all of these functional units may be realized by hardware (including circuit units and circuitry) such as an ASIC, a PLD, or an FPGA or realized by cooperation between software and hardware.

The control unit 12a differs in configuration from the control unit 12 in that the control unit 12a is provided with an angle difference calculating unit 123a instead of the angle difference calculating unit 123 and that the control unit 12a is newly provided with the evaluated value calculating unit 124, the determining unit 125, and the selecting unit 126.

Otherwise, the configuration of the control unit 12a is similar to that of the control unit 12. Therefore, a description of the control unit 12a as a whole will be omitted, and the angle difference calculating unit 123a, the evaluated value calculating unit 124, the determining unit 125 and the selecting unit 126 will be described.

The angle difference calculating unit 123a calculates an angle difference between a beam direction and an interference radio wave direction between two user stations for all combinations of selections of user stations 20.

The evaluated value calculating unit 124 calculates an evaluated value based on a statistic of each angle difference estimated by the angle difference calculating unit 123.

The determining unit 125 performs determination based on the evaluated value calculated by the evaluated value calculating unit 124. For example, the determining unit 125 compares an evaluated value newly calculated by the evaluated value calculating unit 124 (hereinafter, referred to as a “current evaluated value”) and an evaluated value already calculated by the evaluated value calculating unit 124 (hereinafter, referred to as a “past evaluated value”) with each other to determine whether or not the current evaluated value is a maximum evaluated value.

The selecting unit 126 selects a user station set of which inter-user station orthogonality is equal to or more than a threshold as a user station set for performing multi-user transmission on the basis of the evaluated value calculated by the evaluated value calculating unit 124. For example, the selecting unit 126 selects a user station set having the highest inter-user station orthogonality. A highest inter-user station orthogonality means a highest evaluated value.

The storage unit 13a stores antenna information 131, angle difference information 132, and evaluated value information 133. For example, the storage unit 13a is constituted of one or more of an HDD, an SSD, a mask ROM, an EPROM, an EEPROM, and the like.

The evaluated value information 133 is information on the evaluated value calculated by the evaluated value calculating unit 124. Note that information recorded as the evaluated value information 133 in the storage unit 13a is information on a maximized evaluated value. The evaluated value information 133 may be associated with information on a combination of user stations.

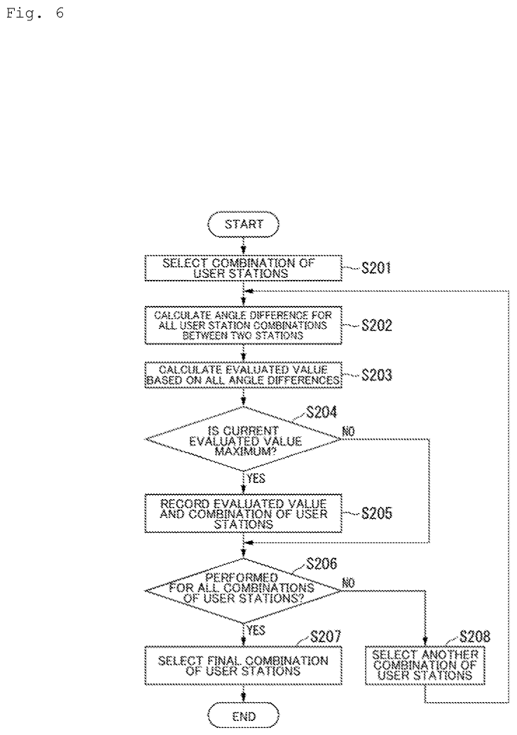

FIG. 6 is a flow chart showing a flow of user station selection processing performed by the base station 10a according to the second embodiment. Let the number of all user stations be denoted by N and the number of multi-user transmissions be denoted by S (where S≤N).

First, the selecting unit 126 selects at random one set of the S-number of multi-user transmissions from all N-number of user stations (S201). The angle difference calculating unit 123a calculates an angle difference between the two user stations for all combinations of two stations for the S-number of user station sets selected by the selecting unit 126 (step S202).

The evaluated value calculating unit 124 calculates an evaluated value on the basis of all angle differences calculated by the angle difference calculating unit 123a (step S203). As the evaluated value, an average value of all angle differences may be used or a minimum value of all angle differences may be used. Otherwise, any evaluated value may be used as long as the present evaluated value indicates a statistical magnitude of all angle differences.

When an average value is used as the evaluated value, even when a singular value such as a significantly large value or small value is present in a part of all angle differences, the average value of all angle differences enables the angle differences as a whole to be evaluated without being dragged by the singular value and the average value can be used in an evaluation guideline as a representative value of all angle differences.

When a minimum value is used as the evaluated value, a minimum value from angle differences of all combinations between two target user stations is to be used as the minimum value of all angle differences and an interference amount between two user stations having the largest interference from the selected user station sets is to be reflected. Therefore, using the present invention as an evaluation guideline is equivalent to using a worst value of interference as an evaluation guideline, and selecting a user station set which maximizes the minimum value of the angle differences enables a user station set which minimizes the worst value of interference to be selected. Thus, user selection can be performed so as to raise a minimum value of radio quality.

The determining unit 125 refers to the evaluated value information 133 and determines whether or not the evaluated value (current evaluated value) calculated by the evaluated value calculating unit 124 is a maximum value among evaluated values (past evaluated values) of S-number of user station sets selected in the past (step S204).

When the current evaluated value is the maximum value (YES in step S204), the determining unit 125 records the current evaluated value and its user station set as the evaluated value information 133 (step S205). At the start of processing, the evaluated value information 133 is not recorded in the storage unit 13a. In this case, the determining unit 125 determines that the current evaluated value is the maximum value.

On the other hand, when the current evaluated value is not the maximum value (NO in step S204), the base station 10a does not execute the processing of step S205 but executes the processing of step S206.

The base station 10a performs the processing of step S202 to step S205 (when the processing of step S204 produces a negative result, the processing of step S205 need not be performed) for all combinations of S-number of user station sets from all of the N-number of user stations. Therefore, the determining unit 125 determines whether or not processing from step S202 to step S205 has been performed with respect to all of the S-number of user station sets (step S206).

When processing from step S202 to step S205 has been performed with respect to all of the S-number of user station sets (YES in step S206), the selecting unit 126 selects the S-number of user station sets recorded in the evaluated value information 133 as the user station set of the final S-number of multi-user transmissions (step S207).

On the other hand, when the processing from step S202 to step S205 has not been performed with respect to all of the S-number of user station sets (NO in step S206), the selecting unit 126 selects another of the S-number of user stations from all the user stations (step S208). For example, the selecting unit 126 selects an unselected user station of the S-number of user stations.

Although the present embodiment represents an example of a method of performing a full search for angular differences of all combinations of user station sets for selecting the number of multi-user transmissions from all the user stations, other embodiments may be adopted as long as the method involves performing a full search.

With the distributed antenna system 100 according to the second embodiment configured as described above, a method is realized in which a user is selected by the number of multi-user transmissions from all the user stations by using an angular difference between two user stations as an evaluation guideline. According to the present invention, during multi-user transmission in a distributed antenna system of a high frequency band, an appropriate user station with high inter-user orthogonality can be selected during multi-user transmission without causing deterioration in transmission efficiency and even if there are a plurality of distributed antennas.

### Third Embodiment

In the user selection method according to the second embodiment, angle differences (ₛC₂ combinations) between two user stations are calculated for all user station sets (_{N}C_{S} combinations) selected from all the S-number of multi-user transmissions from the N-number of user stations, an evaluated value corresponding to a statistical value is calculated from the ₛC₂ combinations of all angle differences, and a maximum user station set is selected. That is, it is necessary to perform a calculation of an angle difference between two stations a total of _{N}Cₛ×ₛC₂ times. The number of calculations becomes huge when the number of all user stations N or the number of multi-user transmissions S increases. For example, when the total number of user stations is 200 and the number of multi-user transmissions is 4, the number of calculations that need to be performed is ₂₀₀C₄×₄C₂=388,109,700 times.

In consideration thereof, the third embodiment is an embodiment that is intended to reduce the number of calculations. More specifically, in the third embodiment, with respect to S-number of multi-user transmissions, S-number of stations are selected one by one instead of being selected all at once. In addition, when newly selecting one station, a user station having a largest angle difference between two user stations from an already-selected user station is selected.

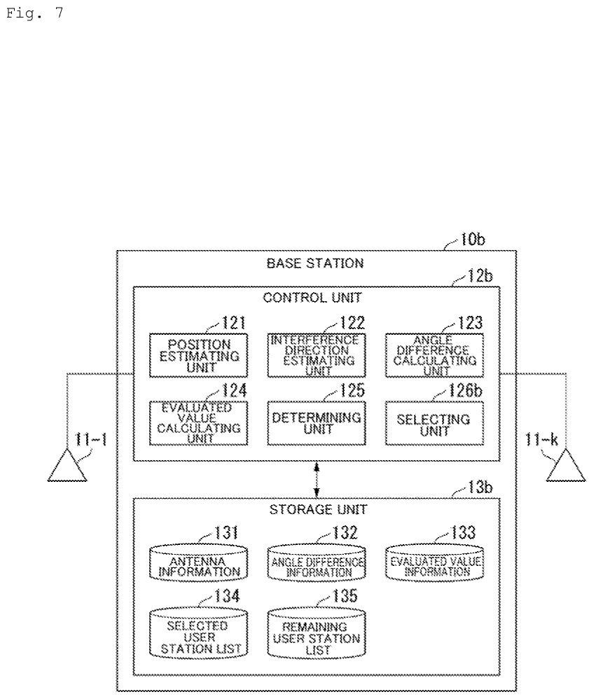

FIG. 7 is a diagram showing a configuration of a base station 10b according to the third embodiment. The base station 10b is provided with distributed antennas 11-1 to 11-2, a control unit 12b, and a storage unit 13b.

The control unit 12b is constituted of a processor such as a CPU and a memory. The control unit 12 executes a program to achieve functions of a position estimating unit 121, an interference direction estimating unit 122, an angle difference calculating unit 123, an evaluated value calculating unit 124, a determining unit 125, and a selecting unit 126b. A part of or all of these functional units may be realized by hardware (including circuit units and circuitry) such as an ASIC, a PLD, or an FPGA or realized by cooperation between software and hardware.

The control unit 12b differs from the control unit 12 in that the control unit 12b includes the selecting unit 126b instead of the selecting unit 126. Otherwise, the configuration of the control unit 12b is similar to that of the control unit 12. For this reason, a description of the control unit 12b as a whole will be omitted and the selecting unit 126b will be described.

The determining unit 125b selects user stations 20 one by one instead of selecting all of the S-number of stations at once as in the second embodiment.

The storage unit 13b stores antenna information 131, angle difference information 132, evaluated value information 133, a selected user station list 134, and a remaining user station list 135. For example, the storage unit 13b is constituted of one or more of an HDD, an SSD, a mask ROM, an EPROM, an EEPROM, and the like.

The selected user station list 134 is a list in which information of user stations 20 already selected at the time of multi-user transmission is registered.

The remaining user station list 135 is a list in which information of user stations 20 which have not been selected at the time of multi-user transmission is registered.

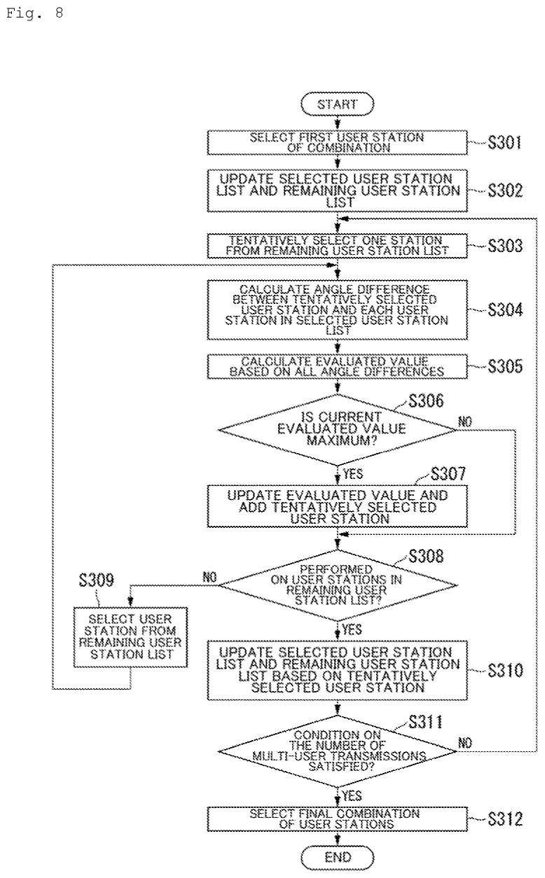

FIG. 8 is a flow chart showing a flow of user station selection processing performed by the base station 10b according to the third embodiment. In the third embodiment, when the processing in FIG. 8 is started, zero information is registered in the selected user station list 134 and information of all user stations 20 is registered in the remaining user station list 135 as initial states. The selecting unit 126b selects a first station from the remaining user station list 135 (step S301). As a method of selecting a first station, the selecting unit 126 may randomly select a user station 20 or select a user station 20 having largest received radio wave intensity.

Random selection as the selection method of the first station can prevent the selection of the first station from being biased. In a case where inter-user interference or, in other words, radio quality when a finally selected user station performs multi-user transmission is heavily dependent on the selection of the first station and an optimal selection thereof is not known, the first station can be selected uniformly so as not to have a deviation in the selection of the first station.

The selection of the user station 20 having a highest received radio wave intensity as the selection method of the first station enables a user station having high interference resistance to be surely incorporated at the time of the present multi-user transmission and the radio quality of the present multi-user transmission is improved.

The selecting unit 126b adds information on the user station 20 selected first to the selected user list 134 and deletes the information from the remaining user station list 135 to update the selected user list 134 and the remaining user station list 135 (step S302). The selecting unit 126b assumes that the user stations 20 in the selected user station list 134 have already been selected and tentatively selects one user station to be selected next from the user stations 20 registered in the remaining user station list 135 (step S303). Hereinafter, the user station 20 having been tentatively selected will be described as a tentatively-selected user station.

The angle difference calculating unit 123 calculates an angle difference between two user stations of the tentatively-selected user station and the user stations 20 registered in the selected user station list 134 (step S304). When only one user station is registered in the selected user station list 134, the angle difference calculating unit 123 calculates the angle difference between two user stations with respect to the one user station, but when a plurality of user stations are registered in the selected user station list 134, the angle difference calculating unit 123 calculates the angle difference between two user stations with respect to each of the user stations 20. The angle difference calculating unit 123 performs this processing for all the user stations 20 registered in the selected user station list 134.

Thereafter, the evaluated value calculating unit 124 calculates an evaluated value on the basis of the statistic of all angle differences calculated by the angle difference calculating unit 123 (step S305). The determining unit 125 refers to the evaluated value information 133 and determines whether or not the evaluated value (current evaluated value) calculated by the evaluated value calculating unit 124 is a maximum value among evaluated values (past evaluated values) of S-number of user station sets selected in the past (step S306).

When the current evaluated value is the maximum value (YES in step S306), the determining unit 125 records the current evaluated value and the information on a tentatively-selected user station as evaluated value information 133 (step S307). At the start of processing, the evaluated value information 133 is not recorded in the storage unit 13a. In this case, the determining unit 125 determines that the current evaluated value is the maximum value.

The tentatively-selected user station is recorded On the other hand, when the current evaluated value is not the maximum value (NO in step S306), the base station 10b executes the processing of step S308 without executing the processing of step S307.

The base station 10b performs the processing of step S304 to step S307 (when the processing of step S306 produces a negative result, the processing of step S307 need not be performed) for all user stations 20 registered in the remaining user station list 135. Therefore, the determining unit 125 determines whether or not processing from step S304 to step S307 has been performed with respect to all of the user stations 20 registered in the remaining user station list 135 (step S308).

When the processing from step S304 to step S307 has not been performed with respect to all of the user stations 20 registered in the remaining user station list 135 (NO in step S308), the selecting unit 126b tentatively selects one unexecuted user station 20 from the user stations 20 registered in the remaining user station list 135 (step S309). Then, the base station 10b executes the processing from step S304 to step S307 with respect to the tentatively selected user station 20.

When the processing from step S304 to step S307 has been performed with respect to all of the user stations 20 registered in the remaining user station list 135 (YES in step S308), the selecting unit 126b adds the tentatively-selected user station 20 with a maximum evaluated value as a newly-selected user station to the selected user station list 134 and deletes the tentatively-selected user station 20 with a maximum evaluated value from the remaining user station list 135 to update the selected user station list 134 and the remaining user station list 135 (step S310).

Thereafter, the determining unit 125 determines whether or not a condition of the number of multi-user transmissions is satisfied on the basis of the selected user station list 134 (step S311). The condition of the number of multi-user transmissions is that, for example, the number of user stations registered in the selected user station list 134 equals the S-number of multi-user transmissions.

When the condition of the number of multi-user transmissions is satisfied (YES in step S311), the selecting unit 126b selects a user station 20 registered in the selected user station list 134 as a user station set of S-number of final multi-user transmissions (step S312).

On the other hand, when the condition of the number of multi-user transmissions is not satisfied (NO in step S311) or, in other words, when the number of user stations in the selected user station list 134 is smaller than the S-number of multi-user transmissions, 10b executes processing of step S303 and thereafter.

According to the distributed antenna system 100 of the third embodiment configured as described above, it is not necessary to calculate the angle difference between two user stations for all combinations of all of the N-number of user stations to the S-number of multi-user transmissions and selections of stations are to be made one by one. Therefore, while the calculation of an angle difference is required to be performed ₙCₛ×ₙCₛ times in the second embodiment, the present method only requires the calculation of an angle difference to be performed 0 times for a first station, (N−1) times for a second station, 2×(N−2) times for a third station, and 3×(N−3) times for a fourth station, and the like. For example, assuming that the total number of user stations is 200 and the number of multi-user transmissions is 4, while the number of calculations of an angle difference that need to be performed in the second embodiment is ₂₀₀C₄×₄C₂=388,109,700 times, the present method only requires calculations of an angle difference to be performed (200−1)+2×(200−1)+3×(200−2)=1,194 times. Therefore, the number of calculations can be reduced.

### Fourth Embodiment

A fourth embodiment is an embodiment in which the number of user stations being a radio transmission partner per distributed antenna is limited. Although the fourth embodiment will be described based on the third embodiment, the fourth embodiment is also applicable to the second embodiment.

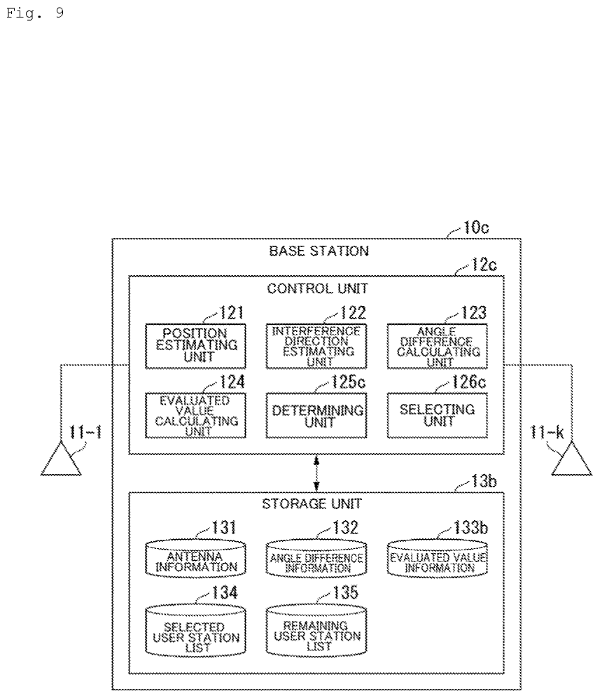

FIG. 9 is a diagram showing a configuration of a base station 10c according to the fourth embodiment. The base station 10c is provided with distributed antennas 11-1 to 11-2, a control unit 12c, and a storage unit 13b.

The control unit 12c is constituted of a processor such as a CPU and a memory. The control unit 12c executes a program to achieve functions of a position estimating unit 121, an interference direction estimating unit 122, an angle difference calculating unit 123, an evaluated value calculating unit 124, a determining unit 125c, and a selecting unit 126c. A part of or all of these functional units may be realized by hardware (including circuit units and circuitry) such as an ASIC, a PLD, or an FPGA or realized by cooperation between software and hardware.

The control unit 12c differs in configuration from the control unit 12b in that it is provided with a determining unit 125c and a selecting unit 126c instead of the determining unit 125 and the selecting unit 126b. Otherwise, the configuration of the control unit 12c is similar to that of the control unit 12b. Therefore, a description of the control unit 12c as a whole will be omitted, and the determining unit 125c and the selecting unit 126c will be described.

The determining unit 125c performs processing similar to that of the determining unit 125. Furthermore, the determining unit 125c performs determination in consideration of an upper limit number A of the number of user stations being a radio transmission partner.

The selecting unit 126c performs processing similar to that of the selecting unit 126b. Furthermore, when one user station is selected from the remaining user station list 135, the selecting unit 126c performs tentative selection in consideration of the upper limit number A of the number of user stations being a radio transmission partner per distributed antenna.

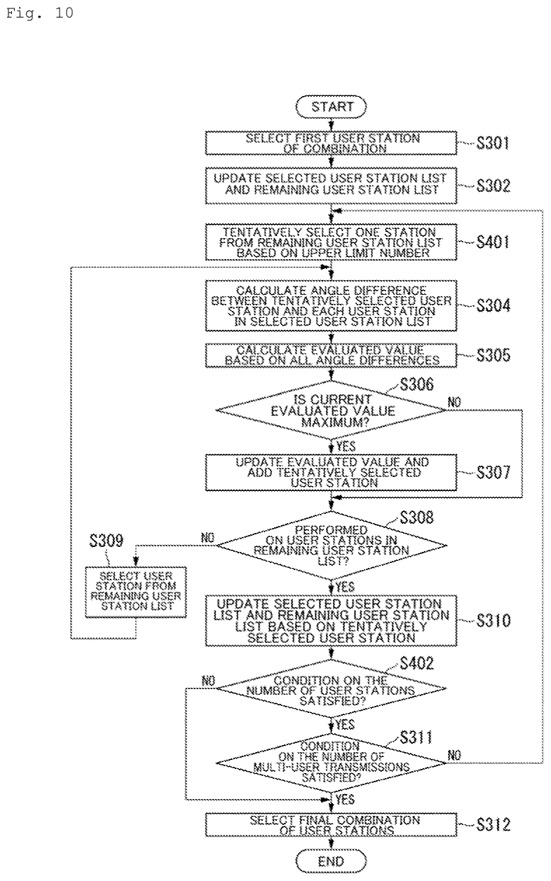

FIG. 10 is a flow chart showing a flow of user station selection processing performed by the base station 10c according to the fourth embodiment. In FIG. 10, processing similar to the third embodiment shown in FIG. 8 will be designated by the same reference signs as in FIG. 8 and will not be described. An upper limit number of the number of user stations being radio transmission partners per distributed antenna is defined as A.

After the processing of step S302, the selecting unit 126c tentatively selects one user station 20 on the basis of the upper limit number A from the remaining user station list 135 (step S401). Specifically, the selecting unit 126c extracts a distributed antenna 11 being a radio transmission partner of A-number of user stations or more of the selected user station list 134 and tentatively selects one user station 20 from other than the user station 20 using the extracted distributed antenna 11 as a radio transmission partner. Thus, the user stations 20 being a radio transmission partner per distributed antenna can be limited to A-number of stations or less.

Subsequently, processing from step S304 to step S310 is executed. Next, after one user station 20 has been added to the selected user station list 134, the determining unit 125c determines whether or not one user station is to be further added to the selected user station list 134 (step S402). In this manner, in the fourth embodiment, determination is made in consideration of the upper limit number A of the number of user stations being a radio transmission partner per distributed antenna in addition to whether or not the number of user stations registered in the selected user station list 134 has reached the number of multi-user transmissions.

Specifically, the determining unit 125c determines whether or not there are user stations 20 having, as a radio transmission partner, the distributed antenna 11 having (A−1)-number of user stations 20 or less being registered in the selected user station list 134 as radio transmission partners among the user stations 20 registered in the remaining user station list 135. When there is no user station 20 (NO in step S402), the number of user stations 20 to be a radio transmission partner of the distributed antenna 11 being the radio transmission partner of the selected user station 20 becomes larger than A regardless of which user station 20 registered in the remaining user station list 135 is selected. That is, the determining unit 125c determines that the condition of the number of user stations is not satisfied. Therefore, even if the number of user stations in the number of selected user station lists 134 does not satisfy the number of multi-user transmissions, the base station 10c executes the processing of step S312. On the other hand, when the user station 20 exists (NO in step S402), the base station 10c executes the processing of step S311.

With the distributed antenna system 100 according to the fourth embodiment configured as described above, the same processing as that of an embodiment of the invention described in claim 3 can be advanced within a range satisfying the upper limit number A of the number of user stations being radio transmission partners per distributed antenna.

In addition, in a similar manner, the second embodiment can also be advanced in a range satisfying the upper limit number A of the number of user stations being radio transmission partners per distributed antenna. For example, it is conceivable to provide a restriction to prevent selection of (A+1)-number or more of the user stations 20 having a same distributed antenna as a radio transmission partner when selecting S-number of stations of the number of multi-user transmissions from all of the N-number of user stations. Otherwise, other flows may be adopted as long as the same processing as an embodiment of the present invention described in claim 2 is advanced within a range satisfying the upper limit number A of the number of user stations being a radio transmission partner per distributed antenna.

In the case of a downlink between user stations 20 having the same distributed antenna as a radio transmission partner, since a side to which interference is given and the radio transmission partner are the same distributed antenna 11, a radio transmission distance and an interference distance are the same and an only reduction element of an amount of interference is a directional gain of a directional antenna. Therefore, the interference amount is highly likely to increase even if the angle difference between two user stations is the same as compared to between user stations having different distributed antennas as radio transmission partners. By providing the upper limit number A to the number of user stations being radio transmission partners per distributed antenna, the present invention enables a user station to be selected during multi-user transmission while suppressing user stations having a same distributed antenna as a radio transmission partner to A-number of stations or less. For example, when A is set to 1 station, multi-user transmission can be prevented from being performed with two or more user stations 20 of the same distributed antenna 11 and a possibility of an increase in an amount of interference can be avoided.

### Fifth Embodiment

There is a possibility that a set of finally selected user stations may vary depending on a selection of a first station from a remaining user station list 135. Therefore, depending on the first selection of the first station, it is impossible to deny the possibility that an angle difference between two user stations of any two of the selected user station sets decreases. A fifth embodiment is an embodiment for avoiding this event. Specifically, the fifth embodiment is a method of re-performing, when an angle difference between two user stations of any two user stations among selected user station sets is less than a threshold, a part of processing. For example, the method involves setting a threshold B to angle difference, and when the angle difference becomes lower than the threshold B, re-performing a part of the processing.

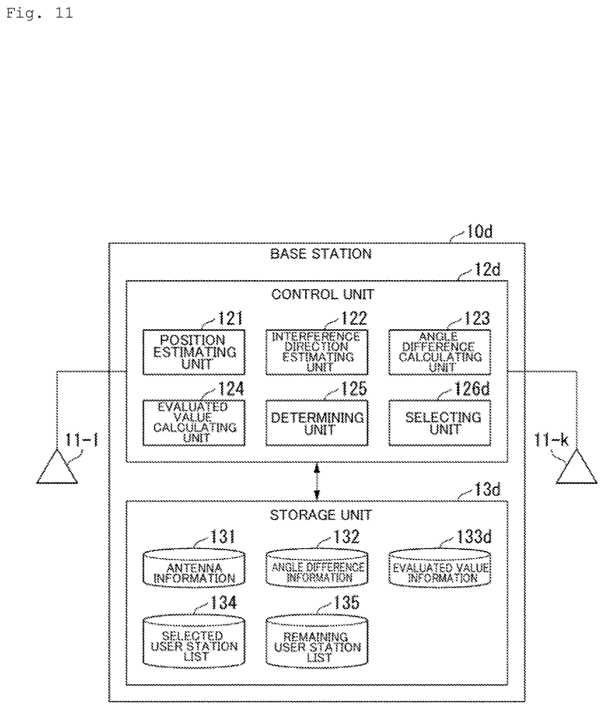

FIG. 11 is a diagram showing a configuration of a base station 10d according to the fifth embodiment. The base station 10d is provided with distributed antennas 11-1 to 11-2, a control unit 12d, and a storage unit 13d.

The control unit 12d is constituted of a processor such as a CPU and a memory. The control unit 12d executes a program to achieve functions of a position estimating unit 121, an interference direction estimating unit 122, an angle difference calculating unit 123, an evaluated value calculating unit 124, a determining unit 125d, and a selecting unit 126d. A part of or all of these functional units may be realized by hardware (including circuit units and circuitry) such as an ASIC, a PLD, or an FPGA or realized by cooperation between software and hardware.

The control unit 12d differs from the control unit 12b in that it includes a selecting unit 126b instead of the selecting unit 126. Otherwise, the configuration of the control unit 12d is similar to that of the control unit 12b. For this reason, a description of the control unit 12d as a whole will be omitted and the selecting unit 126b will be described.

The selecting unit 126b performs processing similar to that of the selecting unit 126b. Further, the selecting unit 126d performs re-selection when an angle difference between two user stations of any two user stations of selected user station sets is less than a threshold.

The storage unit 13d stores antenna information 131, angle difference information 132, evaluated value information 133d, a selected user station list 134, and a remaining user station list 135. For example, the storage unit 13c is constituted of one or more of an HDD, an SSD, a mask ROM, an EPROM, an EEPROM, and the like.

The evaluated value information 133d includes information on a minimum value of all angle differences in addition to information similar to that of the evaluated value information 133.

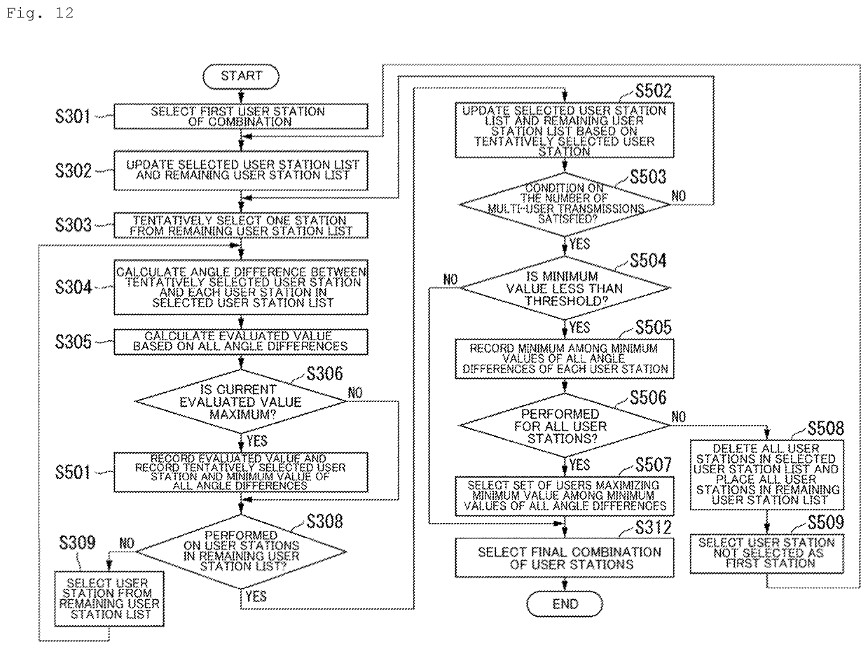

FIG. 12 is a flow chart showing a flow of user station selection processing performed by the base station 10c according to the fifth embodiment. In FIG. 12, processing similar to the third embodiment shown in FIG. 8 will be designated by the same reference signs as in FIG. 8 and will not be described.

When a current evaluated value is a maximum value in the processing of step S306 (YES in step S306), the determining unit 125 records the current evaluated value and information on a tentatively-selected user station as evaluated value information 133. Further, the determining unit 125 also records a minimum value of all angle differences as evaluated value information 133 (step S501). The minimum value of all angle differences is the minimum value among angle differences between two user stations calculated for the current tentatively-selected user station 20 and all user stations 20 registered in the selected user station list 134.

That is, when the selecting unit 126d adds the tentatively-selected user station 20 having a maximum evaluated value to the selected user station list 134 as a newly selected user station and deletes the same from the remaining user station list 135, the minimum value of all angle differences recorded in step D501 is also recorded here (step S502).

The determining unit 125 determines whether or not the number of user stations registered in the selected user station list 134 has reached the number of multi-user transmissions (step S503). When the number of user stations has not reached the number of multi-user transmissions (NO in step S503), the base station 10d executes processing of step S303 and thereafter. On the other hand, when the number of user stations has reached the number of multi-user transmissions (YES in step S503), the determining unit 125 compares the minimum value of all angle differences with the threshold in each user station 20 of the selected user station list 134. As a result, the determining unit 125 determines whether or not there is a user station in which the minimum value of all angle differences is less than a threshold (step S504). When all the minimum values of all angle differences exceed the threshold (NO in step S504), the base station 10d executes the processing of step S312.

On the other hand, when there is even one user station 20 in which the minimum value of all angle differences is less than the threshold (YES in step S504), the determining unit 125 records the minimum value of all angle differences between the user station set of the selected user station list 134 and each user station (step S505). That is, processing is to be performed once again from step S303 after changing the first selection of the first station of the remaining user station list 135. However, since processing must be terminated when the selection of the first one station of the redoing processing has been performed for all user stations, determination processing thereof is performed at this point. That is, the determining unit 125 determines whether or not processing for selecting the first station from the remaining user stations has been performed for all user stations (step S506).

A case where the first station has been selected from remaining user stations for all the user stations (YES in step S506) is a case where the selection of a first station from the remaining user station list 135 has been performed for all user stations and a case where the minimum value of angle differences was unable to fall below the threshold regardless of which user station had been selected first. In this case, the selecting unit 126d finally adds, to the selected user station list 134, a set of user stations 20 of which a minimum value of angle differences is maximized among the user station sets and minimum values of angle differences thereof (step S507).

On the other hand, when the first station has not been selected from remaining user stations for all the user stations (NO in step S506), the selecting unit 126d deletes all the information on user stations 20 registered in the selected user station list 134 and adds the information on all the user stations 20 to the remaining user station list 135 in order to return the selected user station list 134 and the remaining user station list 135 to their initial states (step S508). Subsequently, while the selecting unit 126d selects a first station from the remaining user stations, the selecting unit 126d first selects the user station 20 not having been selected as the first station in order to make a different selection from the previous selection (step S509).

The reason why a determination of whether or not the minimum value of all angle differences is below the threshold is not made at the timing of adding the user stations of the selected user station list 134 but is made at the timing when the number of the user stations of the selected user station list 134 reaches the number of multi-user transmissions is because there is a possibility that the minimum value of all angle differences may fall below the threshold regardless of which user station 20 is selected first and, therefore, it is necessary to record a user station set that reaches the number of multi-user transmissions.

Although the third embodiment has been described as an example in the above embodiment, the fifth embodiment is also applicable to the fourth embodiment.

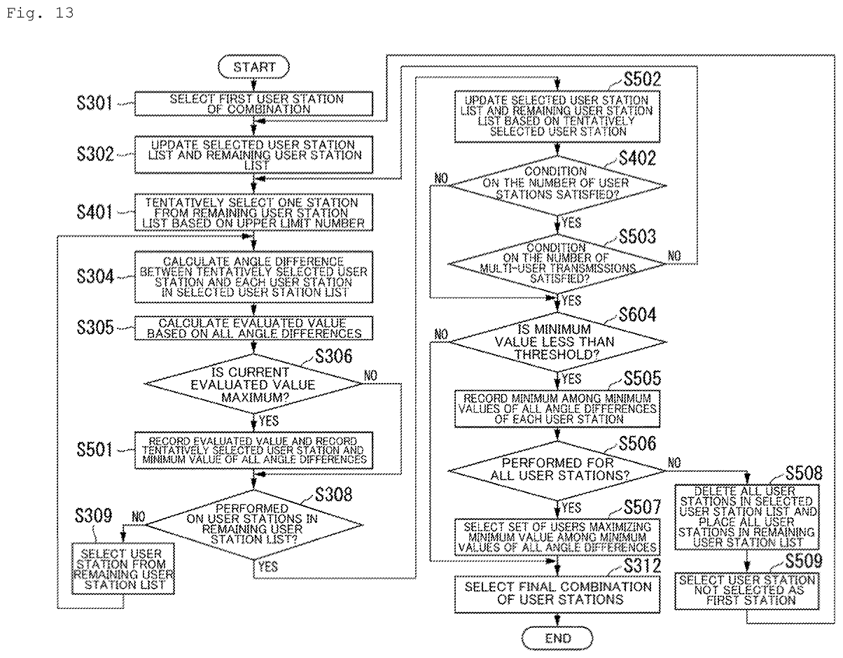

FIG. 13 is a flow chart showing a flow of user station selection processing when the user station selection processing performed by the base station 10c according to the fifth embodiment is applied to the fourth embodiment. In FIG. 13, processing similar to the fourth embodiment shown in FIG. 10 will be designated by the same reference signs as in FIG. 10 and will not be described.

In FIG. 13, the only differences from the processing shown in FIG. 12 is that processing of step S303 in FIG. 12 has been replaced with processing of step S401 and that processing of step S402 is executed after processing of step S502.

With the distributed antenna system 100 according to the fifth embodiment configured as described above, it is possible to set a threshold in advance for an angular difference between two user stations and to try all selections of a first one station in the remaining user station list 135 until the minimum value of all angle differences falls below the threshold. Even when a minimum value of all angle differences does not fall below the threshold regardless of which user station 20 is selected for the selection of the first one station of the remaining user station list 135, a maximum minimum value of all angle differences and a user station set are selected. In this way, the selected user station set can remove an element dependent on the selection of the first one station of the remaining user station list 135.

### Sixth Embodiment

In a sixth embodiment, the user selection methods of the second to fifth embodiments are repeatedly used to repeat user allocation during multi-user transmission, and multi-user transmission is allocated to all user stations of the entire system up to a determined upper limit. Here, a case where the user selection method according to the second embodiment is repeatedly used will be described as an example.

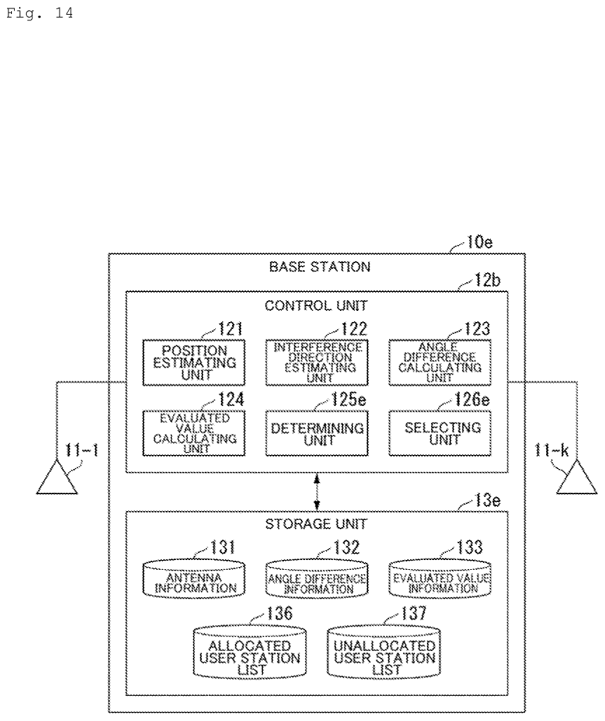

FIG. 14 is a diagram showing a configuration of a base station 10e according to the sixth embodiment. The base station 10a is provided with distributed antennas 11-1 to 11-2, a control unit 12e, and a storage unit 13e.

The control unit 12e is constituted of a processor such as a CPU and a memory. The control unit 12e executes a program to achieve functions of a position estimating unit 121, an interference direction estimating unit 122, an angle difference calculating unit 123, an evaluated value calculating unit 124, a determining unit 125e, and a selecting unit 126e. A part of or all of these functional units may be realized by hardware (including circuit units and circuitry) such as an ASIC, a PLD, or an FPGA or realized by cooperation between software and hardware.

The control unit 12e is different in configuration from the control unit 12a in that it includes a determining unit 125e and a selecting unit 126e instead of the determining unit 125 and the selecting unit 126. Otherwise, the configuration of the control unit 12e is similar to that of the control unit 12a. Therefore, a description of the control unit 12e as a whole will be omitted, and the determining unit 125e and the selecting unit 126e will be described.

The determining unit 125e performs processing similar to that of the determining unit 125. Further, the determining unit 125e determines whether or not allocations of the user station 20 have reached an upper limit number C.

The selecting unit 126e performs processing similar to that of the selecting unit 126. The selecting unit 126e selects the user stations 20 up to the upper limit number C of the number of user stations.

The storage unit 13e stores antenna information 131, angle difference information 132, evaluated value information 133, an allocated user station list 136, and an unallocated user station list 137. For example, the storage unit 13a is constituted of one or more of an HDD, an SSD, a mask ROM, an EPROM, an EEPROM, and the like.

The allocated user station list 136 is a list in which information on allocated user stations 20 is registered as multi-user transmission users.

The unallocated user station list 137 is a list in which information on unallocated user stations 20 is registered as multi-user transmission users.

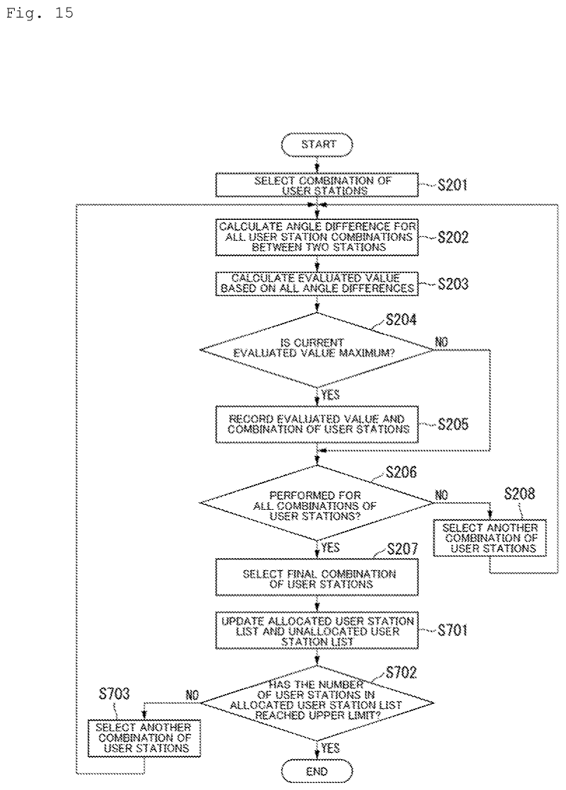

FIG. 15 is a flow chart showing a flow of user station selection processing performed by the base station 10e according to the sixth embodiment. In the sixth embodiment, when the processing in FIG. 15 is started, zero information is registered in the allocated user station list 136 and information of all user stations 20 is registered in the unallocated user station list 137 as initial states. In FIG. 15, processing similar to that in FIG. 6 will be designated by the same reference signs as in FIG. 6, and will not be described.

After the processing of step S207, the selecting unit 126e adds the acquired information of a user selection set at the time of multi-user transmission to the allocated user station list 136, and deletes the information of the user selection set from the unallocated user station list 137 (step S701).

The base station 10e repeats this processing until a user station set at the time of multi-user transmission is allocated to all the user stations 20 of the entire system up to the determined upper limit number C. The determining unit 125e determines whether or not the number of user stations in the allocated user station list 136 has reached the upper limit number C (step S702). When the number of user stations has reached the upper limit number C (YES in step S702), the base station 10e terminates the processing of FIG. 15.

On the other hand, when the number of user stations has not reached the upper limit number C (NO in step S702), the selecting unit 126e selects a combination of other user stations (step S703). For example, when the upper limit number C is set to the total number of user stations of the entire system itself, the user station set at the time of multi-user transmission is to be allocated to all user stations of the entire system by the entire flow shown in FIG. 15. This is processing of allocating a time slot for multi-user transmission to all user stations when a plurality of time slots for multi-user transmission are allocated as one of resource allocation to all user stations in the entire system. For example, assuming that the total number of user stations in the entire system is 200 and the number of multi-user transmissions is 4, resources are allocated to all the user stations in a minimum of 50 time slots for multi-user transmission.

With the distributed antenna system 100 according to the sixth embodiment configured as described above, it is possible to select a user station set having high mutual inter-user station orthogonality from among user station sets allocated to a same time slot. Thus, multi-user transmission with low inter-user interference is enabled and radio capacity can be improved.

When the upper limit number C is set to be smaller than the number of all user stations of the entire system, radio transmission with a different priority for each user station such as multi-user transmission for a part of all user stations and single-user transmission for another part of all user stations is possible and, even in such a case, a user station set having high inter-user orthogonality can be selected during multi-user transmission and multi-user transmission having low inter-user interference can be performed.

Although the embodiments of the present invention have been described in detail with reference to the drawings, specific configurations are not limited to these embodiments, and designs and the like within a range that does not deviate from the gist of the present invention are also included.

The base stations 10, 10a, 10b, 10c, 10d, and 10e according to the embodiments described above may be realized by a computer. In such a case, the program to realize their functions may be recorded on a computer-readable recording medium and the program recorded on the recording medium may be read and executed by a computer system. In addition, the program may be provided through a network such as the Internet. It is understood that the term “computer system” as used herein includes an OS and hardware such as peripheral devices. In addition, a “computer-readable recording medium” refers to a portable medium such as a flexible disk, a magneto-optical disk, a ROM, or a CD-ROM, or a storage apparatus such as a hard disk that is built into the computer system.

The “computer-readable recording medium” may also include a medium that holds the program dynamically for a short period, for example a communication line in a case where the program is transmitted over a network such as the Internet or a communication line such as a telephone line, or a medium that holds the program for a fixed period, for example a volatile memory in the interior of a computer system that serves as the server or the client in the aforesaid case. Moreover, the program described above may be any of a program for realizing some of the functions described above, a program capable of realizing the foregoing functions in combination with a program already recorded in a computer system, and a program that is realized using a programmable logic device such as an FPGA (Field Programmable Gate Array).

Although embodiments of the present invention have been described in detail with reference to the drawings, specific configurations are not limited to these embodiments, and designs and the like within a range that does not deviate from the gist of the present invention are also included.

### INDUSTRIAL APPLICABILITY

The present invention can be applied to a technique for estimating inter-user orthogonality during multi-user transmission in a distributed antenna system.

### REFERENCE SIGNS LIST

10, 10a, 10b, 10c, 10d, 10e Base station
20-1 to 20-k User station
11-1 to 11-3 Distributed antenna
21-1 to 21-2 Antenna
12, 12a, 12b, 12c, 12d Control unit
13, 13a, 13b, 13d, 13e Storage unit
121 Position estimating unit
122 Interference direction estimating unit
123, 123a Angle difference calculating unit
124 Evaluated value calculating unit
125, 125c, 125e Determining unit
126, 126b, 126c, 126d, 126e Selecting unit

1. A method of estimating inter-user orthogonality in a distributed antenna system in which a base station includes a plurality of distributed antennas installed at a plurality of locations and which performs simultaneous radio transmissions with a plurality of user stations, the method of estimating inter-user orthogonality comprising the steps of:
estimating a position of each of the user stations on the basis of installation positions of the plurality of distributed antennas, beam directions of the plurality of distributed antennas to each user station being a radio transmission partner, and an antenna height of each of the user stations;
estimating an interference radio wave direction on the basis of the position of each of the user stations estimated in the step of estimating a position and installation positions of the plurality of distributed antennas; and
calculating an angle difference between the beam direction and the interference radio wave direction to estimate orthogonality between the user stations.

2. The method of estimating inter-user orthogonality according to claim 1, wherein in the step of calculating an angle difference, an angle difference between the beam direction and the interference radio wave direction between two user stations are calculated for all combinations of user station selection, and the method of estimating inter-user orthogonality further comprises the steps of:
calculating an evaluated value based on a statistic of each of the calculated angle differences; and
selecting a set of user stations in which the inter-user station orthogonality is equal to or greater than a threshold on the basis of the calculated evaluated value.

3. The method of estimating inter-user orthogonality according to claim 1, wherein in the step of calculating an angle difference, an angle difference between the beam direction and the interference radio wave direction between two user stations is calculated for selected user stations in user station selection, and the method of estimating inter-user orthogonality further comprises the steps of:
calculating an evaluated value based on a statistic of each of the calculated angle differences; and
selecting a set of user stations one by one on the basis of the calculated evaluated value.

4. The method of estimating inter-user orthogonality according to claim 3, wherein in the step of selecting, a user station to be a first station of the set of user stations is selected at random.

5. The method of estimating inter-user orthogonality according to claim 3, wherein in the step of selecting, a user station of which reception radio wave intensity is equal to or greater than a threshold is selected as a user station to be a first station of the set of user stations.

6. The method of estimating inter-user orthogonality according to claim 2, wherein in the step of selecting, the number of user stations being a radio transmission partner per distributed antenna of the base station is selected to be less than a predetermined threshold.

7. The method of estimating inter-user orthogonality according to claim 3, wherein in the step of selecting, when the angle difference between the beam direction and the interference radio wave direction is less than a certain threshold with respect to a combination of selected user stations, the user stations are selected once again.

8. The method of estimating inter-user orthogonality according to claim 2, wherein in the step of calculating an evaluated value, the evaluated value is set as an average value of the angular differences.

9. The method of estimating inter-user orthogonality according to claim 2, wherein in the step of calculating an evaluated value, the evaluated value is set as a minimum value of the angle differences.

10. The method of estimating inter-user orthogonality according to claim 2, wherein in the step of selecting, the selection of the user stations is repeated a predetermined number of times to select a plurality of combinations of user stations for multi-user transmission.

11. A base station in a distributed antenna system in which a base station includes a plurality of distributed antennas installed at a plurality of locations and which performs simultaneous radio transmissions with a plurality of user stations, the base station comprising:
a processor; and
a storage medium having computer program instructions stored thereon, when executed by the processor, perform to:
estimate a position of each user station on the basis of installation positions of the plurality of distributed antennas, beam directions of the plurality of distributed antennas to each user station being a radio transmission partner, and an antenna height of each of the user stations;
estimate an interference radio wave direction on the basis of the position of each of the user stations and installation positions of the plurality of distributed antennas; and
calculate an angle difference between the beam direction and the interference radio wave direction to estimate orthogonality between the user stations.
